(19) United States
(12) Patent Application Publication
(10) Pub. No.: US 2025/0276664 A1
(43) Pub. Date: Sep. 4, 2025

(54) SCREEN CAPTURE TOOL FOR AUTOMOTIVE DIAGNOSTIC SCOPES

(71) Applicant: Randal S. Nichols

(72) Inventor: Randal S. Nichols

(21) Appl. No.: 19/068,438

(22) Filed: Mar. 3, 2025

Related U.S. Application Data
(60) Provisional application No. 63/560,204, filed on Mar. 1, 2024.

(51) Int. Cl. B60R 21/017; B60R 21/01; G06F 3/02; G06F 3/0484

(52) U.S. Cl. CPC B60R 21/0173; G06F 3/0202; G06F 3/0484; B60R 2021/01054

(57) ABSTRACT

A screen capture tool includes a set of programmatic instructions, a main body, a system controller, a pair of communication cables, and a remote-control unit. The first communication cable includes a USB cable that receives power from an automotive diagnostic scope and sends digital information to the scope. The second communication cable includes a coaxial cable that sends analog or digital information to the diagnostic channel input of the scope. When the scope is connected to a vehicle, the scope displays continuous real time diagnostic information about the vehicle on the display screen of the scope as the vehicle is being driven. The remote button is depressed upon encountering a malfunction of the vehicle to freeze the image on the display and to display a marker indicating the time the error was detected.

### CROSS-REFERENCE TO RELATED APPLICATIONS

This application claims the benefit of U.S. Application Ser. No. 63/560,204 filed on Mar. 1, 2024, the contents of which are incorporated herein by reference.

### TECHNICAL FIELD

The present invention relates generally to automotive diagnostic tools, and more particularly to a screen capture tool for use with an automotive diagnostic scope.

### BACKGROUND

The statements in this section merely provide background information related to the present disclosure and may not constitute prior art.

Modern automotive vehicles are incredibly complex machines that typically include dozens of individual computers and thousands of connected electrical components. As such, when an electrical failure in an automotive system occurs, a technician must attempt to diagnose the cause of the failure by troubleshooting many interrelated systems. With particular regard to intermittent electrical/electronic failures, the technician must be able to duplicate the problem when the vehicle is connected to their diagnostic equipment such as the technician's automotive diagnostic scope, for example.

Unfortunately, because diagnostic scopes are designed to display information from a connected vehicle in real time, it is exceedingly difficult for a single technician to capture information using a diagnostic scope when the vehicle is moving. To this end, for problems that can only be duplicated when the vehicle is being driven, the technician must split their attention between the display screen of their scope, and safely operating the vehicle.

Accordingly, it would be beneficial to provide a screen capture tool for an automotive diagnostic scope that can be used by a technician to quickly and easily capture diagnostic information of a vehicle in motion so as to overcome the drawbacks noted above.

### SUMMARY OF THE INVENTION

The present invention is directed to a tool having a main body, a system controller, a pair of communication cables, and a remote control unit. The communication cables of the tool can be connected to an automotive diagnostic scope and can work in conjunction with a set of programmatic instructions for causing the scope to perform functionality when the button of the remote-control unit is depressed.

In one embodiment, the first communication cable can include a USB cable that receives power from the diagnostic scope and sends digital information to the scope. The second communication cable can include a coaxial cable that sends analog or digital information to a diagnostic channel input of the scope.

When the scope is connected to a vehicle, the scope can display continuous real time diagnostic information about the vehicle on the display screen of the scope as the vehicle is being driven. When a technician detects a malfunction of the vehicle, the image on the display screen can be frozen via the button on the remote-control unit. Upon pressing the button, the controller instructs the display screen to generate a user-defined marker indicating the time the error was detected.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a screen capture device that is useful for understanding the inventive concepts disclosed herein.

FIG. 2 is a simplified block diagram of the system controller of the device, in accordance with one embodiment of the invention.

FIG. 3 is an exemplary flowchart illustrating a method of connecting and operating the device, in accordance with one embodiment of the invention.

FIG. 4 is a perspective view of the device in operation, in accordance with one embodiment of the invention.

FIG. 5 is an exemplary display screen generated by the diagnostic scope connected to the device, in accordance with one embodiment of the invention.

FIG. 6 is another exemplary display screen generated by the diagnostic scope connected to the device, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described herein, the term “removably secured,” and derivatives thereof shall be used to describe a situation wherein two or more objects are joined together in a non-permanent manner so as to allow the same objects to be repeatedly joined and separated.

As described herein, the inventive device 10 can be utilized with an automotive mechanic diagnostic tablet, such as the Verus Edge Automotive Diagnostic and Information Tool having an onboard scope module that is commercially available from SNAP-ON, for example. Of course, the device is not limited to this particular type or brand of automotive scope, as any number of other types and/or brands of scopes are also contemplated.

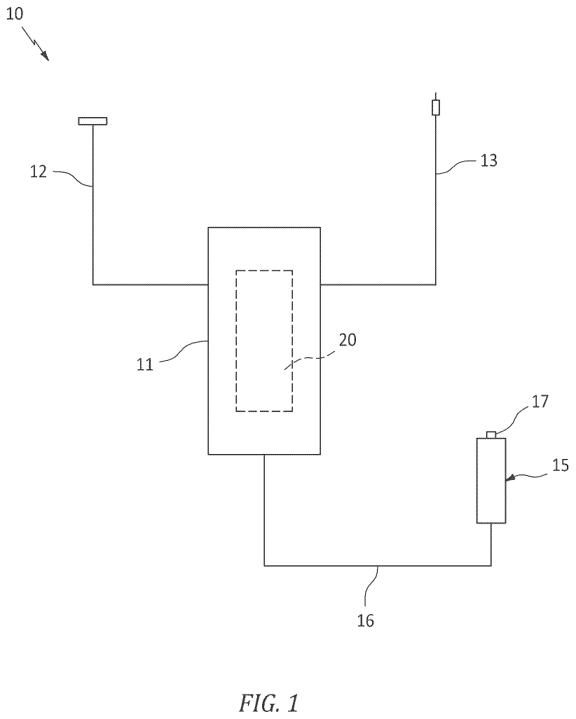

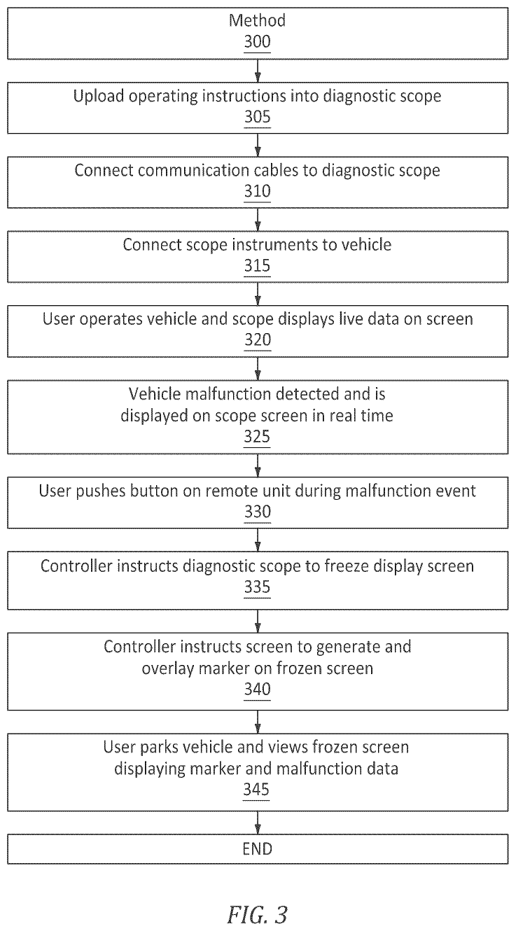

FIGS. 1-6 illustrate one embodiment of a screen capture tool device 10 that is useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure.

As shown best at FIG. 1, one embodiment of the device 10 can include a main body 11, a remote-control unit 15 and a system controller 20.

The main body 11 can function to securely house the system controller 20. The main body can include any number of different shapes and sizes and can be constructed from any number of different materials that are relatively strong for their weight. Several nonlimiting examples include various plastics and metals, for example. In the preferred embodiment, the main body will include a watertight internal space into which the controller 20 can be housed. The main body can also include any number of different internal tabs for securely engaging the controller so as to allow the controller to be resistant to shocks as may happen if/when the device is dropped.

In one embodiment, a first communication cable 12 can be connected to the system controller 20 and can extend outward from the main body 11. In the preferred embodiment, the first cable 12 can include, comprise, or consist of a USB cable that can send and receive instructions with a diagnostic scope and that can provide power from the scope to the device 10.

In one embodiment, a second communication cable 13 can also be connected to the system controller 20 and can extend outward from the main body 11. In the preferred embodiment, the second cable 13 can include, comprise or consist of an analog-type cable such as an oscilloscope or coaxial cable, for example, that can be connected to one of the diagnostic channels on the automotive scope.

Although described above with regard to two cables, each having a specific makeup and communication protocol, this is for illustrative purposes only, as the inventive device can include any number of other types of communication cables capable of performing any number of different functions.

In one embodiment, a remote-control unit 15 can be connected to the main body 11 and controller 20 via a cable 16. The remote-control unit can include a housing having a button 17 or other user actuation device that can be selectively depressed by a user as will be described below.

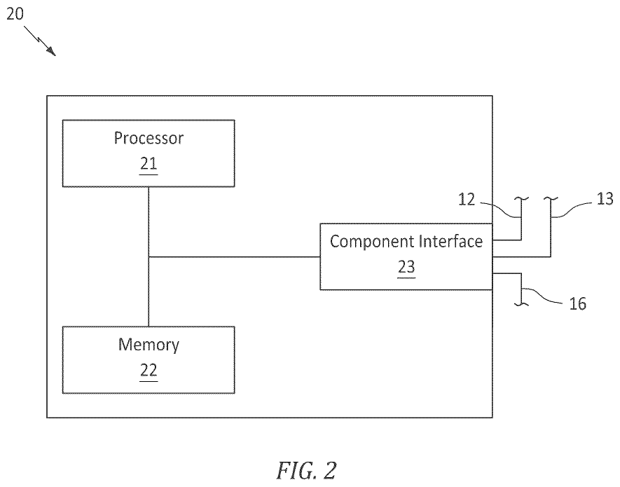

FIG. 2 is a simplistic block diagram illustrating one embodiment of the system controller 20. As shown, one embodiment of the controller 20 can include a processing unit 21 that is conventionally connected to an internal memory 22, and a component interface unit 23.

Although illustrated as separate elements, those of skill in the art will recognize that one or more system components 21-23 may include, comprise, or consist of one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processing unit 21 can include one or more central processing units (CPU) or any other type of device, or multiple devices, capable of manipulating or processing information such as program code stored in the memory 22 in order to allow the device to perform the functionality described herein.

Memory 22 can act to store operating instructions in the form of program code for the processing unit 21 to execute. Although illustrated in FIG. 2 as a single component, memory 22 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device.

The component interface unit 23 can function to provide a communicative link between the processing unit 21 and various system elements such as the communication cables 12, 13 and 16, along with the remote unit 15, for example. In this regard, the component interface unit can include any number of different components such as one or more PIC microcontrollers, standard bus, internal bus, connection cables, and/or associated hardware capable of linking the various components.

A method 300 of installing and operating the screen capture tool can include the following steps. Although described with regard to a particular order or number of steps, this is for illustrative purposes only, as any number of other steps and arrangement of steps are contemplated.

The method can begin at step 305 wherein a user can first upload an operating program into their diagnostic scope for which the device 10 is to be used with. The operating program can be provided on removable USB thumb drive or other mechanisms and can include a set of programmatic instructions for allowing the particular scope to operate with the device 10. At this stage, the user can be provided with options for adjusting the appearance and/or location of the marker to be displayed on the screen as will be described below.

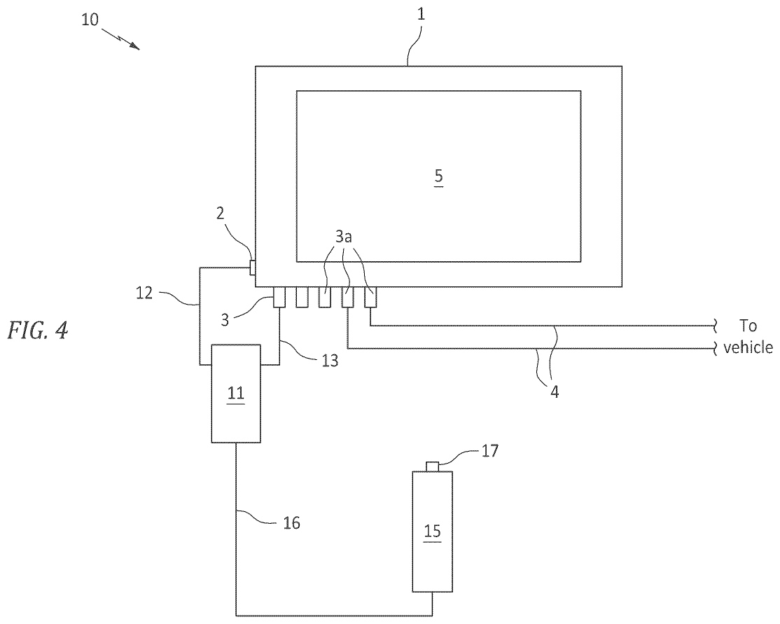

Next, the method can proceed to step 310 where the user can connect the device 10 to the automotive scope 1. As shown best at FIG. 4, in one embodiment the first communication cable 12 can be plugged into the USB port 2 of the scope, and the second communication cable 13 can be plugged into one of the diagnostic channel inputs 3 of the scope.

Next, the method can proceed to step 315 where the user can connect the scope to the vehicle being diagnosed. For example, the user can plug any number of leads 4 from the scopes other diagnostic input channels 3a to various portions of the automobile where the technical issue is believed to reside.

Once connected in the manner described above, the method can proceed to step 320 where user can operate the vehicle under the conditions where the technical issue is reported to occur. For example, the user may need to drive the vehicle a set speed, distance, RPM, or time, for example. As shown at FIG. 4, when the technician is driving the vehicle, the screen 5 of the scope 1 will display continuous real time diagnostic information 51 from the vehicle that is received via the leads 4 and input channels 3a, for example. However, because the user is driving, he or she will not be able to view the display screen.

When the vehicle experiences the reported technical issue at step 325, data pertaining to the error will be displayed in the continuous real-time diagnostic information 51. During this time, the method can proceed to step 330 where the user can depress the button 17 of the remote-control unit wherein the controller can activate the communication cables 12 and 13 to simultaneously output signals to the scope 1.

In this regard, the controller can send a first signal through the first cable 12 to the USB port 2 of the scope. Upon receiving the first signal the scope will freeze the image being displayed on the screen 5 at step 335 in accordance with the set of programmatic instructions received at step 305. Such a feature provides a fixed image/snapshot of the diagnostic information 51 during the technical issue and prevents the same from being lost as the screen would otherwise continue to scroll and collect new data.

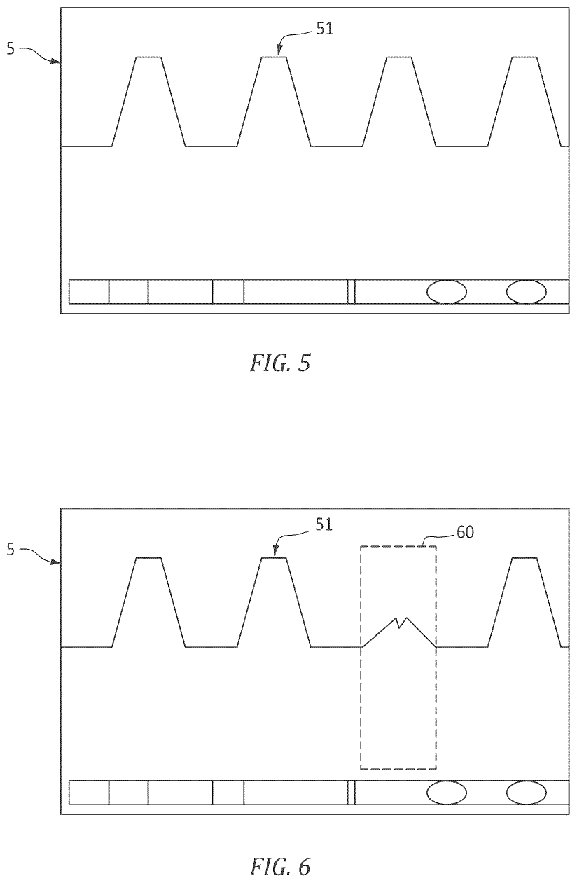

Additionally, the controller can send a second signal through the second cable 13 to the diagnostic channel input 3 of the scope. As shown at FIG. 5, upon receiving this second signal, the scope will generate a marker 60 to appear on the screen at step 340 beginning when the capture button 17 was pressed and in accordance with the set of programmatic instructions and user customization received at step 305.

Once the information has been captured and frozen on the display screen, the method can proceed to step 345 where the user can park the vehicle and view the results from the safety of the parked vehicle.

Providing an automotive technician with the ability to freeze images on the display screen of their diagnostic scope via the push of a button without having to view and operate the scope directly is a critical feature of the present invention, as such a feature ensures the technician is able to concentrate safely operating the vehicle at all times. Moreover, by providing a marker indicating the exact moment the error is noticed (via engagement of the remote capture button) the device advantageously provides critical data to the technician to pinpoint actions that trigger the vehicle malfunction and allows them to quickly diagnose and ultimately repair the same.

As to a further description of the manner and use of the present invention, the same should be apparent from the above description. Accordingly, no further discussion relating to the manner of usage and operation will be provided.

Although described above with regard to diagnosing automotive electrical issues using an automotive diagnostic scope, this is but one possible implementation of the inventive device. As such, many other uses are also contemplated.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device, comprising:
a main body;
a first communication cable that is configured to engage a diagnostic scope device;
a second communication cable that is configured to engage the diagnostic scope device;
a remote control unit; and
a controller that is connected to each of the first communication cable, the second communication cable and the remote control unit,
wherein the controller includes functionality for instructing the diagnostic scope to perform at least one of selectively freezing an image displayed on a screen of the diagnostic scope, and generating an image to appear on the screen of the diagnostic scope.

2. The device of claim 1, wherein the diagnostic scope comprises an automotive diagnostic scope.

3. The device of claim 2, wherein the first communication cable functions to receive power from the automotive diagnostic scope.

4. The device of claim 3, wherein the first communication cable comprises a USB cable.

5. The device of claim 4, wherein the diagnostic scope is connected to a vehicle and the image displayed on the screen of the diagnostic scope represents a technical issue with the vehicle.

6. The device of claim 1, wherein the remote control unit includes a main body, a communication cable and a push button.

7. A method, comprising:
providing a device having a main body, a controller, a pair of communication cables, and a remote control unit,
connecting the pair of communication cables to a diagnostic scope;
connecting the diagnostic scope to a vehicle;
displaying diagnostic information of the vehicle on a display screen of the diagnostic scope;
detecting a malfunction of the vehicle; and
freezing an image displayed on the display screen of the diagnostic scope.

8. The method of claim 7, wherein the diagnostic scope comprises an automotive diagnostic scope.

9. The method of claim 8, further comprising:
depressing a button on the remote control unit to cause the image displayed on the display screen to be frozen.
